(19) United States
(12) Patent Application Publication
(10) Pub. No.: US 2015/0006585 A1
(43) Pub. Date: Jan. 1, 2015

(54) MULTITHREADED CODE GENERATOR FOR DISTRIBUTED MEMORY SYSTEMS

(71) Applicant: Texas Multicore Technologies, Inc., Austin, TX (US)

(72) Inventors: Brad Nemanich, Austin, TX (US); David P. Sheth, Austin, TX (US)

(21) Appl. No.: 14/321,245

(22) Filed: Jul. 1, 2014

Related U.S. Application Data
(60) Provisional application No. 61/841,898, filed on Jul. 1, 2013.

(51) Int. Cl. G06F 17/30

(52) U.S. Cl. CPC G06F 17/3056; G06F 17/30607; G06F 8/315
USPC 707/792

(57) ABSTRACT

Each machine runs a single process; in which each process calls a function generated by the SequenceL™ compiler, the generated SequenceL™ function being multi-threaded, allowing the generated SequenceL™ function to run on all of the cores of the machine at once. The user does not have to be concerned about introducing bugs that are difficult to diagnose and correct, and the program does not have the overhead of running many message passing processes on the same machine.

### FIELD

This disclosure relates to distributed memory systems.

### BACKGROUND

A Map Reduce framework, such as Hadoop® (a registered trademark of The Apache Software Foundation Corp.), has three distinct steps: Map, Shuffle, and Reduce. The first step, the Map, takes as input a set of data and a mapper. The mapper is code provided by the user which will operate on one item in the set of data. The framework is responsible for breaking the input data into individual items, and feeding those items, one at a time, to the mapper code. The mapper code is responsible for outputting results in the form of key value pairs.

The framework performs the second step, the Shuffle, without any code provided by the user. This step collects the output from the Map step, groups it by the keys, and feeds the groups to the third step.

The third step, the Reducer takes as input the groups, and uses reducer code that is provided by the user. The framework is responsible for feeding one group of data at a time to the reducer code, which operates on a group of data to produce output. The framework collects the output from the reducer code for final output.

### BRIEF DESCRIPTION OF DRAWINGS

FIG. 1 is a block diagram of a framework, according to an implementation;

FIG. 2 is a block diagram of a map, according to an implementation;

FIG. 3 is a flowchart of a mapper, according to an implementation;

FIG. 4 is a flowchart of a mapper, according to an implementation; and

FIG. 5 is a flowchart of a MPI program, according to an implementation.

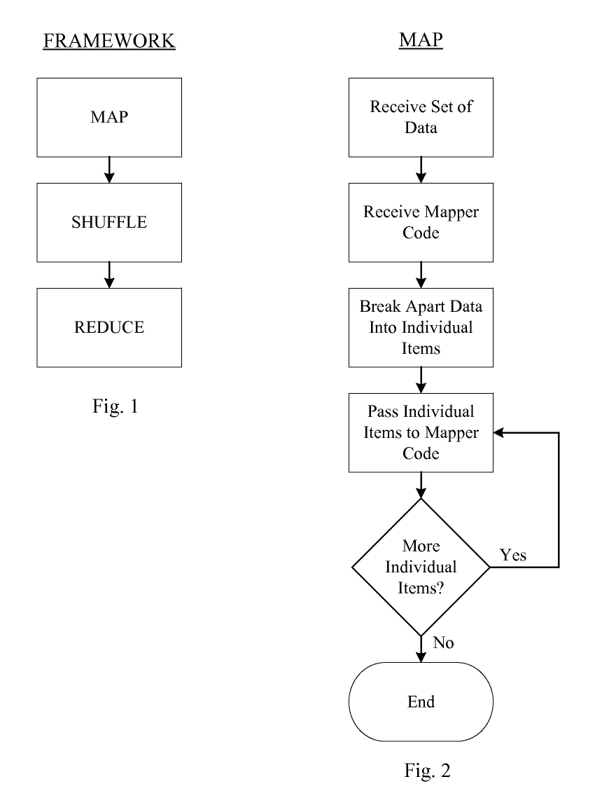

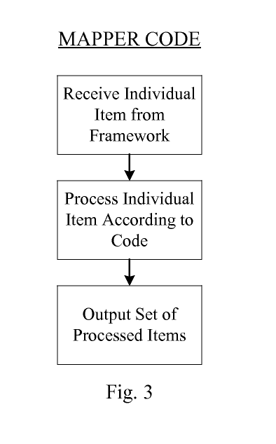

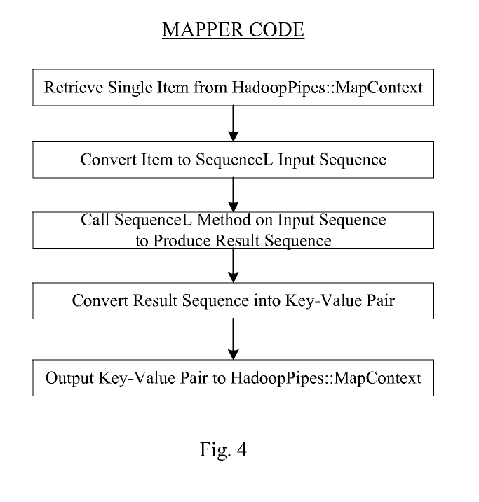

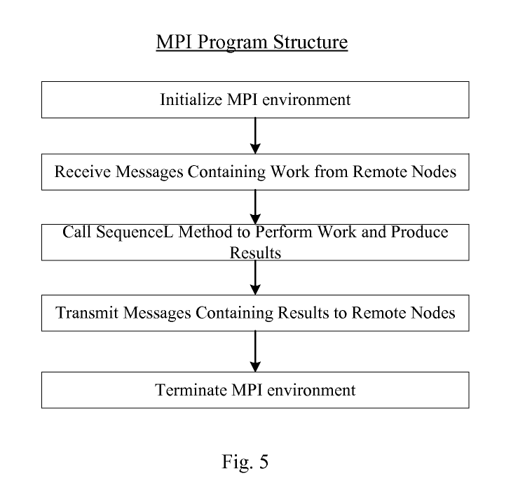

### DETAILED DESCRIPTION

SequenceL™ (a trademark of Texas Multicore Technologies, Inc.) runs on a shared memory system. For clarity, a shared memory system offers a single memory space shared by all processors wherein the processors do not have to be aware of where data to be operated on resides. It takes as input any number of items, such as floats, arrays, and matrices (of various dimensions), processes the data, and outputs the result. During the processing step, SequenceL™ parallelizes the problem and runs it across many cores in the shared memory system. This can be understood by reference to U.S. patent application Ser. No. 12/711,614 herein incorporated by reference, which describes a method for generating multithreaded code for execution on the multiple cores of a computer system. The use of multithreaded code requires a computer system with a shared memory between the multiple coresFor clarity, as opposed to a shared memory system, a distributed memory system is a multiple-processor computer system in which each processor has its own private memory (or more likely, several individual multiple-core computer systems each with their own private memory). As such, distributed memory systems can only operate on local data and any remote data that is required must be communicated to the one or more “remote” processors.

### Types of Hadoop® Programs

As one particular example, there are three types of user supplied mapper or reducer programs that Hadoop® can use. The first is a Java application, written in a specific way. When this approach is used, Hadoop® will pass data to the Java program in a highly efficient way (by reference). The second is a C++ program written in a specific way. When this approach is used, Hadoop® will pass data to the C++ program via a socket. The second approach is called “pipes,” and it is slower than the first approach because of the additional overhead of passing data via a socket. The third approach is to use a program written in a specific way, written in any language. When this approach is used, Hadoop® will pass data to the program via standard input and output. This is the least efficient way to pass data. As described in the next section, all three approaches described are either slow when they use only a single core, or cumbersome to write and prone to subtle defects when they attempt to take advantage of all the cores in a multicore processor.

Multicore Approaches with Hadoop®

For Hadoop® to take advantage of all the cores on a computer, there are three possible approaches. The first two are the standard ways, which have problems. The third approach is to adapt SequenceL™ to be used in a manner which avoids the problems of the first two approaches.

The first approach is to run a mapper on each core on a machine. For example, if there are 8 cores, then one would run 8 mappers. Hadoop® specifies to each mapper how much memory it can consume. If there is one mapper per core, then the most memory that each mapper can use is the total amount of memory, divided by the number of cores. For example, if there is 4G on the computer with 8 cores, Hadoop® would be configured so that each mapper gets 500M. With this approach, items that require more than 500M of memory to process will fail. The solution to this limitation is to increase the amount of memory per mapper, but this requires fewer mappers to run on the box, thus not making use of all available cores.

The second approach is for a user to write correct high performance multithreaded Java or C++ code. The problem with this approach is that it is a large effort with a high likelihood of introducing bugs that are difficult to diagnose and correct. Additionally, the performance on larger machines is likely to be suboptimal because Java does not expose NUMA (Non-Uniform Memory Access) primitives to the author of the multithreaded code.

The third approach is to use SequenceL™ in an unintended manner. In this approach, some special driver code is written that allows a SequenceL™ program to serve as a mapper or reducer. The purpose of this driver code is to mediate between the C++ code expected by the Hadoop® framework and the C++ code generated by the SequenceL™ compiler. One instance of SequenceL™ runs on each computer, and in each case, that instance makes use of all the cores on that particular machine. With this approach, large problems can be solved using all the cores and all available memory on the machine.

### Implementation of the Hadoop®/SequenceL™ Approach

The specific implementation is object-oriented C++ code written to interface with Hadoop® using its pipes interface, and to interface with SequenceL™ via method calls. To do this, the code implements both a mapper and reducer. The mapper extends the Hadoop®Pipes::Mapper class and overrides its map function. This map function takes a Hadoop®Pipes::MapContext. The code calls this context object to retrieve input data from Hadoop®, then places it in SequenceL™ specific data structures, and then calls SequenceL™ methods. The results of this call are then emitted back to Hadoop®, so that the rest of the process can continue. When the C++ program is compiled, all the necessary supporting libraries for a Hadoop® pipes program and all the necessary supporting libraries for a SequenceL™ program must be linked together. In addition, all necessary supporting libraries must be made available on the machines where the code is running.

The reducer code acts in much the same way. Note that when the reducer code is simple (such as simply counting items) this may be performed directly in the C++ code that sits between Hadoop® and SequenceL™, instead of calling SequenceL™.

### MPI SequenceL™ Description

Message Passing Framework is a framework for performing computations across a distributed system. The framework provides methods for each node (e.g. each individual computer system) on the system to communicate with each other by passing messages. These messages can include data or instructions to perform. Message passing allows for systems to communicate without shared memory (e.g. distributed memory environments).

A user will create a program that utilizes a Message Passing Framework, such as the Message Passing Interface (MPI). The user's program is responsible for choosing which messages will be sent to which node on the system. The framework is responsible for handling the details of sending the message on one node and receiving the message on another node. The user's program is then responsible for handling the message once it is received.

### SequenceL™

SequenceL™ runs only on shared memory systems. It takes as input any number of items, such as floats, arrays, and matrices (of various dimensions), processes the data, and outputs the result. During the processing step, it parallelizes the problem and runs it across many cores in the shared memory system.

### Types of Message Passing Frameworks

The most common method of message passing is using the Message Passing Interface (MPI) framework. This framework works with many different languages, such as C, C++ and Fortran. There are also other, less popular, frameworks such as Parallel Virtual Machine (PVM).

Multicore Approaches with Message Passing

For message passing frameworks to take advantage of all the cores on a computer (e.g. a node), there are three possible approaches. The first two are the standard ways, which have problems. The third approach is to use SequenceL™ in a manner for which it was not intended or designed to operate, which avoids the problems of the first two approaches.

The first approach is to run a separate process on each core of a machine. For example, if there are 8 cores, then one would run 8 processes. Each program would have its own address space and could only communicate with the other processes using the Message Passing Framework. This inter-program communication adds more overhead than having 8 threads running within a shared address space that can communicate without sending messages.

The second approach is for a user to write correct high performance multithreaded code. The problem with this approach is that it is a large effort with a high likelihood of introducing bugs that are difficult to diagnose and correct.

The third approach is to use SequenceL™ in a manner for which it was not intended or designed to operate. In this approach, each machine runs a single process. This process can call a function generated by the SequenceL™ compiler. The generated SequenceL™ function will be multi-threaded, allowing it to run on all of the cores of the machine at once. With this approach, the user does not have to worry about introducing bugs that are difficult to diagnose and correct, and the program does not have the overhead of running many message passing processes on the same machine.

### Implementation of the MPI/SequenceL™ Approach

An implementation can be written within any language that has an MPI library and can call C-style functions. One exemplary method is to create a C++ program that includes an MPI library. This program will first initialize MPI. After initialization comes the code that will be executed on each machine. This section will contain function calls to the MPI library to send and retrieve messages. It will also contain calls to SequenceL™ functions. These SequenceL™ functions will perform multi-threaded computations on data and return a result.

The C++ program will be compiled with a C++ compiler and an MPI build script. When the C++ compiler is called, all of the necessary supporting libraries for a SequenceL™ program must be linked together. In addition, all necessary supporting libraries must be made available on the machines where the code is running.

1. Apparatus comprising:
a map reduce framework including a map object a shuffle object and a reduction object;
a second framework that operates in shared memory having a single memory space shared by multiple processors wherein the processors do not have to be aware of where data to be operated on resides and that receives any number of items, such as floats, arrays, and matrices, processes the data, and outputs a result, during a processing step, parallelizes a process and runs the process across multiple cores in the multiple processors in a shared memory system; the second framework further comprising a mapper object and a reducer object,
the mapper object comprising an object method that extends the map object of the map reduce framework to retrieve input data then place the input in framework data structures, and then call map reduce framework methods,
the reduction object comprising an object method that extends the map object of the map reduce framework to retrieve input data then place the input in framework data structures, and then call map reduce framework methods.

2. The apparatus of claim 1 wherein the map object of the map reduce framework further comprises:
an object method that receives a set of data and a mapper, wherein the mapper includes computer instructions provided by an operator which will operate on one item in a set of data, and that breaks the input data into individual items, and feeding those items, one at a time, to a mapper code, wherein the mapper code is responsible for outputting results in a form of key value pairs.

3. The apparatus of claim 2 wherein the shuffle object of the map reduce framework further comprises:
an object method that collects the output from the map object, groups the output by the keys, and transmits the groups to the reduced object.

4. The apparatus of claim 3 wherein the reducer object of the map reduce framework further comprises:
an object method that receives the groups, and executes reducer code that is provided by the operator.
